(19) United States
(12) Patent Application Publication
(10) Pub. No.: US 2017/0332653 A1
(43) Pub. Date: Nov. 23, 2017

(54) PROCESS OF MANUFACTURING MILK CURD AND CHEESE BY DIRECT CHEMICAL ACIDIFICATION

(71) Applicant: Universidad Nacional de Colombia, Medellin (CO)

(72) Inventors: Fernando ARENAS GIL, Medellin (CO); José Víctor HIGUERA MARIN, Medellin (CO)

(21) Appl. No.: 15/524,215

(22) PCT Filed: Nov. 6, 2015
(86) PCT No.: PCT/IB2015/002267

§ 371 Date: May 3, 2017

(30) Foreign Application Priority Data
Nov. 6, 2014 (CO) 14-245769

(51) Int. Cl. A23C 19/045; A23C 19/064; A23C 19/05; A23C 19/068; A23C 19/097; A23C 19/076

(52) U.S. Cl. CPC A23C 19/0455; A23C 19/0973; A23C 19/076; A23C 19/052; A23C 19/0684; A23C 19/064; A23C 19/0688

(57) ABSTRACT

A fast and efficient process to manufacture milk curd by direct chemical acidification with acid. The process comprises the steps of heating the milk to a temperature sufficient to pasteurize the milk, cooling the milk, coagulating the milk with the addition of an acid, and incubating the milk and acid mixture for a set period of time. The resulting curd may be employed in the manufacture of different varieties of cheese to which it is subjected to additional steps of salting, molding and/or pressing.

### CLAIM OF PRIORITY

This application claims the benefit of application Ser. No. 14/245,769, filed on Nov. 6, 2014. The entire contents of the foregoing are incorporated herein by reference.

### TECHNICAL FIELD

The present invention is related to a new process for the fast and efficient manufacture of milk curd and cheeses by a direct chemical acidification method, where acid is the sole coagulating agent. The process comprises heating the milk to a temperature sufficient to pasteurize the milk, cooling the milk, coagulating the milk with the addition of a fruit acid, and incubating the milk for a set period of time. The process disclosed produces milk curds quickly and efficiently, which can be further employed in the manufacture of a variety of dairy products including cheese and yogurt. The methods described herein can produce a cheese or yogurt with an increased shelf-life and enhanced nutritional value due to significant levels of vitamin C.

### BACKGROUND

Curd is a dairy food derived from the coagulation or precipitation of casein by the action of a coagulating agent. Casein is a phosphoprotein which at its isoelectric point reaches its lower solubility and precipitates (coagulates) forming an appropriate mass to make cheese.

Cheese is one of the main agricultural products in the world, with global production, according to FAO data, nearly 20 million tons annually. There are many characteristics that define the variety of cheese, including the origin of the milk used, the degree and time of maturity, its fat content and the geographical area where applicable.

In the conventional manufacture of curd and cheese, milk is inoculated with a bacterial culture capable of converting lactose into lactic acid and obtaining an adequate acidity to allow coagulation of casein, to reach this acidity coagulating enzymes such as chymosin are used. The resulting curd, separate from the whey, may be salted and pressed to obtain a block of cheese which can also be matured during certain periods of time under controlled conditions to obtain different varieties.

To carry out the process on an industrial level, it is necessary to have equipment such as pasteurizers, retention basins, cutting lyres, stirring vats and ripening equipment to control temperature and aging time depending on the desired type of cheese. For example, for Edam cheese it is required a maturing time of 3 months at a temperature between 12° C. and 14° C., whereas for Parmesan cheese the temperature should be below 10° C.

The document U.S. Pat. No. 7,329,424 describes a process for manufacturing cheeses and other dairy products in which lactobionic acid is added or is generated in situ by an oxidase lactose that degrades lactose to lactobionic acid. Using this lactobionic acid, either in free form or in salt form, allows direct acidic coagulation without adding bacterial cultures, creates greater efficiency and yields to obtain cheese with good organoleptic properties.

In situ generation of lactobionic acid in cheese manufacture effectively reduces the lactose content of the milk component allowing to obtain cheeses with a very low lactose content. However, to obtain cheese by this process, temperatures above 80° C. and very extensive manufacturing times are handled. The process also does not allow to make Parmesan, Mozzarella, Edam, Soft and Fresh Ricotta cheese.

The document EP2612556 describes a process for producing cheese and curd without addition of lactobacilli or milk enzymes. In the process acidulants such as acetic acid or citric acid are used and sodium bicarbonate and yeast extract are added to obtain cheeses that don't need to be ripened. Although in this process low temperatures and relatively short manufacturing times are handled, cheeses obtained do not have suitable organoleptic texture and their flavor characteristics and long term stability are very limited.

In one aspect, the present invention describes a process to obtain curd faster and more efficiently by acidification of milk with ascorbic acid. Once obtained, different varieties of cheese can be made using the curd. In the process of the invention it is not necessary to add enzymes, bacterial or yeast cultures or extracts, allowing a more direct and efficient coagulation of milk, thus reducing the processing time, resulting in increased performance, longer life and better organoleptic characteristics.

### SUMMARY

The present invention is related to a process for the manufacture of curds, several types of cheese such as Cream, Double Cream, Parmesan, Ricotta and Edam, and yogurt wherein acid is used as the sole coagulating agent. The process includes heating the milk, cooling, coagulation with an acid, and incubation of the coagulated milk curds. To prepare the cheeses, the curd can also be separated from the whey and subjected to salting, molding and/or pressing.

By the process of the invention described herein, higher performance is achieved, and the organoleptic characteristics, physicochemical properties, and microbiological stability of the curds and cheeses are improved. Cheeses obtained using the methods described herein reach useful shelf-lives of up to 180 days or longer if kept refrigerated. Additionally, the addition of fruit acids such as ascorbic acid allows the curd and cheeses obtained to be fortified with vitamin C, which functions as an antioxidant and cofactor.

In one aspect, this disclosure features methods for preparing milk curd comprising a) milk skimming; b) heating; c) temperature drop; d) coagulation using ascorbic acid; e) residence; and f) separation of the curd. In some cases, the milk is bovine milk, goat milk, buffalo milk or mixtures thereof.

In some cases, during the skimming the fat is separated until milk reaches a fat content less of 0.5% p/p. In some cases, the milk is taken in the heating step to a temperature between 90.0° C. and 100.0° C. In some cases, the step of lowering the temperature, it is reduced by 25% with respect to the heating temperature of the milk.

In some cases, ascorbic acid or a salt thereof is used as coagulating agent. In some cases, the amount of ascorbic acid added is between 0.5% and 10.0% by weight relative to the total weight of mixture (e.g., between 0.5% and 2% by weight). In some cases, in the step of residence the mixture is left to stand for a period of time between 1 and 30 minutes. In some cases, the separation of curd is performed by draining the whey with a sieve which retains the curd.

In some embodiments, the process further comprises salting, molding and/or pressing. In some cases, in the step of salting, salt is added to the curd in an amount between 0.01% and 10.0% by weight relative to the total weight of curd (e.g., between 1% and 1.5% by weight). In some cases, in the molding step, the salted curd is placed in a mold with a defined geometric shape. In some cases, the pressing step is carried out a pneumatic press at a pressure between 130 and 200 KPa (e.g., between 150 and 200 Kpa) for 20 to 60 minutes.

In another aspect, this disclosure features milk curd obtained by the processes described herein. In some cases, the milk curd contains between 0.01% and 5.0% (e.g., between 0.2% and 0.25%) residual vitamin C.

In another aspect, this disclosure features cheese obtained by the processes described herein. In some cases, the cheese is characterized by having a lifetime between 60 and 180 days, cooled to 4° C. In some cases, the cheese is a cream cheese, a double cream cheese, fresh cheese, a type of Parmesan cheese, a type of Edam cheese or ricotta cheese. In some cases, the cheese contains between 0.01% and 5.0% (e.g., between 0.2% and 0.25%) residual vitamin C.

In another aspect, this disclosure features a method for preparing milk curds comprising: a) heating raw milk to a temperature sufficient to pasteurize the milk; b) cooling the milk; c) adding a fruit acid to the milk in an amount sufficient to achieve a pH in the range of 3.5 to 6.6 (e.g., between 3.5 and 5.5, or a pH of approximately 3.7, 3.8, 4.9, 5.1, 5.25, and 5.5); and d) incubating the milk and acid mixture; wherein the acid coagulates the milk to form a composition comprising milk curds. In some cases, the method comprises heating the raw milk to a temperature of at least 92° C. In some cases, the method comprises cooling the milk. In some cases, the method comprises cooling the milk to a temperature selected from the group consisting of approximately 75° C., 77.5° C., 88° C., and 92° C. In some cases, the fruit acid comprises an acid or a salt thereof selected from the group consisting of ascorbic acid, citric acid, lactic acid, malic acid, steric acid, tartaric acid, and combinations thereof. In some cases, the acid is ascorbic acid or a salt thereof. In some cases, the amount of ascorbic acid added is between 0.5% and 10.0% by weight relative to the total weight of the mixture (e.g., between 0.5% and 2%). In some cases, the incubation time is at least 1 minute. In some cases, the incubation time is less than 30 minutes. In some cases, 1 to 4 grams of water are absorbed per gram of protein during this incubation. In some cases, the acid coagulates the milk to form a mixture comprising milk curds and whey and the method further comprises separating the curds from the whey.

In some embodiments, the method further comprises salting the curds. In some embodiments, the method further comprises molding the curds. In some embodiments, the method further comprises pressing the curds.

In some cases, the salt is added to the curds in an amount between 0.01% and 10.0% by weight relative to the total weight of curds (e.g., between 1% and 1.5% by weight). In some cases, the method comprises pressing the curds at a pressure between 130 and 200 KPa (e.g., between 150 and 200 Kpa) for 20 to 60 minutes.

In some embodiments, the milk is selected from the group consisting of bovine milk, goat milk, buffalo milk and mixtures thereof.

In another aspect, this disclosure features milk curd obtained by the methods described herein. In some cases, the milk curd is characterized by containing between 0.01% and 5.0% residual vitamin C (e.g., approximately between 0.2% and 0.25% residual vitamin C or approximately 30% to 40% of the vitamin C added).

In another aspect, this disclosure features cheese obtained by the methods described herein. In some cases, the cheese is characterized by having a lifetime between 60 and 180 days, cooled to 4° C. In some cases, the cheese is cream cheese, a type of mozzarella, fresh white cheese, Parmesan cheese, Edam cheese or ricotta cheese. In some cases, the cheese is characterized by containing between 0.01% and 5.0% residual vitamin C (e.g., between 0.2% and 0.25%, or approximately 0.2 to 0.25 grams of vitamin C for every 100 grams of cheese).

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the description and drawings, and from the claims.

### DETAILED DESCRIPTION OF THE INVENTION

This disclosure is based in part on the discovery that it is possible to coagulate milk proteins through the addition of acid, towards the manufacture of curds, cheeses, and yogurt. To that end, the present application discloses a method for producing various types of cheese, curds, or yogurt from whole raw milk by controlling the temperature and pH of production.

As described here, the method comprises heating the milk, cooling the milk, adding a calculated amount of acid, and incubating the milk mixture. The process can also include filtering the curds from the whey, pressing the mixture to remove excess water, molding the mixture, salting the mixture, adding sugar, adding fat, or any combination thereof.

The processes described herein involve the heating and cooling of the milk prior to coagulation. The milk is heated to a temperature sufficient to kill the acid producing bacteria and yeast naturally-occurring in the milk, i.e., sufficient to pasteurize the milk. This pasteurization can be either slow or HTST pasteurization. This heating of the milk to decrease the naturally occurring acid-producing bacteria in the milk allows for control of the pH and % total acid of the mixture, solely through the addition of acid to the milk. The heating step can be carried in a pasteurizer or in heating marmites until it reaches a temperature between 90° C. and 100° C. and held for a time of 2 to 10 seconds (e.g., 2, 3, 4, 5, 6, 7, 8, 9, or 10 seconds).

The cooling temperature depends on the desired type of cheese. Table 1 shows the different temperatures of the process depending on the type of cheese to be produced.

TABLE 1

| | Cooling temperature |
|---|---|
| Type of Cheese | (° C.) |
| Cream Cheese | 75.0 ± 0.5 |
| Parmesan Cheese | 88.0 ± 0.5 |
| Double Cream Cheese | 75.0 ± 0.5 |
| (type of Mozzarella) | |
| Fresh White Cheese | 77.5 ± 0.5 |
| Edam Cheese | 77.5 ± 0.5 |

After the milk mixture is cooled, the addition of between 0.5% and 10.0% (e.g., between 0.5% and 3.0%, e.g., approximately 0.5, 1, 2, 3, 4, 5, 6, 7, 8, 9 or 10%) by weight of acid relative to the total weight is added to coagulate the milk proteins. This mixture of milk and acid is then homogenized. The added acid can be in an aqueous solution or a soluble salt thereof. As with the temperature, the type of cheese to obtain determines the amount of acid added. Table 2 shows the various amounts of ascorbic acid added for each of the types of cheese made by the present method.

TABLE 2

| | Amount of ascorbic |
|---|---|
| Type of Cheese | acid (% w/w) |
| Cream Cheese | 0.50 ± 0.05 |
| Parmesan Cheese | 2.50 ± 0.5 |
| Double Cream Cheese, | 0.75 ± 0.05 |
| Fresh White Cheese | |
| and Edam | |
| Ricotta Cheese | 2.00 ± 0.1 |

As described herein, the production employs acid to induce the coagulation of the milk proteins. In some cases the acid is a fruit acid. Acids suitable for use in the present methods include but are not limited to ascorbic, citric, lactic, malic, steric, tartaric acid. In addition the acidity of the milk itself can be used to augment the process. The production described herein can also use acid derived from a fruit (e.g., lemons, limes, mandarins, grape fruit, oranges, passion fruit, carambola, cherry, guava, tamarind, currant, apple, pear, gooseberry, borojo, mulberry, strawberry, grape or any combinations thereof). The amount of acid added in order to achieve a final mixture with the desired pH value is dependent on the acidity of the raw milk. The acidity of raw milk increases over time due to natural bacterial and yeast cultures. In the process described, the heating step kills the naturally-occurring cultures in the raw milk, and live cultures or extracts thereof are not added in subsequent steps. As such, the acidity of the raw milk before beginning the process described herein, will affect the amount of acid to be added in order to achieve a certain pH. The desired pH is different depending on the type of cheese being produced. The pH can range from approximately 3.5 to approximately 6.6. In some cases the pH can range from approximately 3.5 to 5.5. In some cases the pH can range from approximately 4 to 5.5. In some cases the pH is approximately 3.7, 3.8, 4.9, 5.1, or 5.25. In some cases the pH is between 5.3 and 5.5 (e.g., 5.5±0.2).

Upon completion of the coagulation with acid, the mixture is incubated for a period of time, called residence time, which can be 1 to 30 minutes (e.g. 1, 2, 3, 4, 5, 10, 15, 20, 25, or 30 minutes) and varies depending on the type of cheese being manufactured. Table 3 shows the different residence times for each of the cheeses.

TABLE 3

| Type of Cheese | Residence Times (min) |
|---|---|
| Cream Cheese | 15 ± 2 |
| Parmesan Cheese | 0.5 ± 0.2 |
| Double Cream Cheese | 10 ± 2 |
| Fresh White Cheese | 7 ± 1 |
| Edam | 5 ± 1 |
| Ricotta Cheese | 5 ± 2 |

After the residence time, two phases can be distinguished in the mixture: a solid phase called the curd and a liquid phase corresponding to the whey. The curds can be separated from the whey by draining the whey into another container, or by passing the two components through a sieve where the curd is retained.

Subsequently, different varieties of cheese can be made from curd obtained by subjecting it to salting steps, molding and/or pressing. The salting step can involve homogeneously adding salt (NaCl) to the curd, the amount of salt to be added depends on the type of cheese and can vary from 0.01% to 10.0% (e.g., from 1% to 1.5%, or approximately 1, 1.1, 1.2, 1.3, 1.4, 1.5, 2, 3, 4, 5, 6, 7, 8, 9 or 10%) by weight of salt based on the total weight curd. The curds can also be placed in a mold having the desired geometric shape and pressing it. This step of pressing the cheese can occur at a pressure between 130 and 200 KPa (e.g., approximately 130, 140, 150, 160, 170, 180, 190, or 200 kPA) for 20 to 60 minutes (e.g., approximately 20, 25, 30, 40, 50 or 60 minutes) to obtain the cheese.

Prior to the processing of the milk, the method can further include the steps of skimming the milk fat. In the step of skimming, the fat is separated to a fat content in the milk less than 0.5% w/w and can be performed in a skimmer centrifuge.

### Examples

The following examples further illustrate the invention, without being restricted to the same inventive concept.

### Example 1. Preparation of Milk Curds

100 kg of bovine milk were heated to a temperature of 92.0° C.; held for 6 seconds at that temperature and then cooled to 75.0° C. After cooling, 500 grams of ascorbic acid were added and the mixture was shaken with a mechanical stirrer at 60 rpm for 6 seconds.

The mixture was then incubated for 15 minutes (residence time was 15 minutes). After 15 minutes of setting, the whey was removed by passing the mixture through a sieve. 35 kg of curd were obtained with a 0.2% of vitamin C and residual shelf-life of 60 days, when cooled to 4° C.

### Example 2. Preparation of Cream Cheese

100 kg of milk were heated to a temperature of 92° C.; held for 6 seconds and then cooled to 75° C. 500 grams of ascorbic acid were added and shaken with a mechanical stirrer at 60 rpm for 6 seconds. The pH of the milk and acid preparation was approximately 5.25.

The mixture was incubated for 15 minutes and then the curd was separated from the whey by passing the mixture through a sieve and draining the whey. 525 grams of salt were then added and mixed with the curds.

This process resulted in 35 kg of cream cheese with a 0.2% residual vitamin C and a lifetime of 60 days when cooled to 4° C.

### Example 3. Preparation of a Type of Parmesan Cheese

100 kg of milk were heated to a temperature of 92° C., held for 6 seconds and then cooled to 88° C. 3.0 kg of ascorbic acid were added and homogenized with a mechanical stirrer at 60 rpm for 6 seconds. The pH of the milk and acid preparation was approximately 3.8.

The mixture was incubated for approximately 0.5 minutes and then the curd was separated from the whey by passing the mixture through a sieve. Following separating of the whey, 156 grams of salt were added to the curd homogeneously. Finally, the curds were placed in a cubic mold and pressed in a pneumatic press at 150 to 200 KPa for 25 minutes to obtain the final product.

This process produced 13 kg of Parmesan Cheese with a content of 0.6% residual vitamin C and a shelf-life of 120 days, cooled to 4° C.

### Example 4. Preparation of a Type of Mozzarella

100 kg of milk were heated in a heating marmite to a temperature of 92° C., held for 6 seconds and then cooled to 75° C. 750 grams of ascorbic acid were added and homogenized with a mechanical stirrer at 60 rpm for 6 seconds. The pH of the milk and acid preparation was approximately 4.9.

The mixture was incubated for 10 minutes and then the curd was separated from whey by passing the mixture through a sieve. 160 grams of salt were added to the curd homogeneously. Finally, the curd was placed in a cubic mold and pressed in a pneumatic press at 150 to 200 KPa for 25 minutes to obtain the final product.

This process produced 16 kg of a type mozzarella with a 0.2% residual vitamin C with a shelf-life of 60 days, when cooled to 4° C.

### Example 5. Preparation of Fresh White Cheese

100 kg of milk were heated to a temperature of 92° C., held at that temperature for 6 seconds and then cooled to 77.5° C. 750 grams of ascorbic acid were then added and homogenized with a mechanical stirrer at 60 rpm for 6 seconds. The pH of the mixture was approximately 5.1.

The mixture was incubated for 7 minutes and curd was separated from whey by passing the mixture through a sieve. 130 grams of salt were added to the curd homogeneously. Finally, the curd was placed in a cubic mold and pressed in a pneumatic press at 150 to 200 KPa for 25 minutes to obtain the final product.

This process produced 13 kg of Fresh White Cheese with 0.2% residual vitamin C and a lifetime of 180 days (cooled to 4° C.).

### Example 6. Preparation of a Type of Edam Cheese

100 kg of milk were heated to a temperature of 92° C.; held for 6 seconds and then cooled to 77.5° C. 750 grams of ascorbic acid were added and shaken with a mechanical stirrer at 60 rpm for 6 seconds. The pH of the mixture was approximately 4.9.

The mixture was incubated for 5 minutes and the curd was separated from whey by passing the mixture through a sieve and draining the whey for 30 minutes. 130 grams of salt were then added to the curd homogeneously. Finally, the curd was placed in a cubic mold and pressed in a pneumatic press at 150 to 200 KPa for 25 minutes to obtain the final product.

This process resulted in 13 kg of Edam Cheese with a content of 0.2% residual vitamin C and a shelf-life of 180 days, cooled to 4° C.

### Example 7. Preparation of Ricotta Cheese

100 kg of milk were skimmed in a skimming centrifuge which was heated to 45° C. and centrifuged at 8000 rpm for 20 minutes. This skimmed milk was then heated in a steam heating marmite to a temperature of 92.0° C.; held for 6 seconds and then cooled to 75° C. 2.0 kg of ascorbic acid were added and homogenized with a mechanical stirrer at 60 rpm for 6 seconds. The mixture had a pH of approximately 3.7.

This mixture was incubated for 5 minutes and the curd was separated from whey by passing the mixture through a sieve and letting the whey drip. 420 grams of salt were added to the curd homogeneously.

The process resulted in 35 kg of Ricotta Cheese with a content of 0.4% residual vitamin C and a lifetime of 60 days, cooled to 4° C.

### Example 8: Preparation of Yogurt

10% by weight, based on the total weight of milk was added to the raw milk. This mixture was then heated to a temperature sufficient to pasteurize the milk (e.g., 92° C.). It was then cooled to 45° C. and 0.5% to 0.7% ascorbic acid was added. The mixture was incubated and at this point flavoring could be added and well blended. The flavoring can be any preferred flavoring, for example flavoring could be added in the form a fruit syrup or fruit pulp. The yogurt is then kept refrigerated at 2° C. to 4° C.

### Example 9: Analysis of Residual Vitamin C

The addition of ascorbic acid not only denatures of the proteins of the milk but it also increases the amount of vitamin C present in the final product. This is beneficial as the cheese can be used as a nutritional supplement towards the goal of achieving the recommended daily amounts of vitamin C.

The residual presence of vitamin C was measured in all the cheeses by chromatography by HPLC in the following manner: 10 g of sample was mixed with approximately 20 mL distilled water and 5 ml of tricloro-acetic acid CCl3COOH analytical grade a 40% PN. This mixture is homogenized using ultrasound for an hour (Bransor 3510). The mixture was then centrifuged at 7000 g for 15 min with refrigeration at 5° C. to prevent the decomposition of vitamin C. The supernatant was collected, the volume noted, and filtered through 0.45 μm nylon. This filtered mixture was put in a glass vial and injected in the HPLC for analysis. The conditions for the HPLC analysis are as follows:

Equipment: Liquid Chromatography Shimadzu UFLC

Column: Premier C18, 5 μm, 250 mm×4.6 μm i.d

Mobile Phase (Buffer): 100% phosphate buffer, 0.02 M

Injection volume: 5 μL

Temperature: 35° C.

Wave length: 244 nm

A standard curve of vitamin C using known amounts of a 99% pure standard and performing the same process of extraction outlined above was used to evaluate the percent yield of this extraction method. Using the process of cheese and yogurt production described herein, the average vitamin C present in the vial sample is 0.7427 mg/ml and in the final products the average amount was 0.5 mg of vitamin C per 100 mg of cheese.

### Example 10: Preparation of Cheese and Yogurt Drink Using Fruit Pulp

Milk was heated until 92° C. and then let cool to 75° C.

The amount of fruit pulp was calculated that contains sufficient acid to equal 0.63% by weight of the amount of milk and was added to the milk. For example, the milk was mixed with an amount of maracuya fruit pulp, and the amount of fruit pulp to be added was calculated such that the citric acid present in the added fruit pulp was equivalent to the 0.63% by weight of the milk. The final mixture of the milk and the fruit was 0.75% acid because the milk itself contained 0.12% acid by weight, i.e., 0.63% acid from the fruit and 0.12% acid from the milk=0.75% total acid (% by weight).

The milk and fruit milk mixture was incubated for 5 minutes and then the curds were separated by filtration from the liquid. The curds were pressed in a pneumatic press at 250 KPa. The liquid obtained by straining the curds was packed as a dairy drink with fruit.

This process using fruit pulp yielded approximately 15% of cheese and 85% of dairy drink. This process can be performed with a variety of fruits.

It should be understood that the present invention is not limited to the described and illustrated modalities, for as will be apparent to one skilled in the art, there are variations and possible modifications which do not depart from the spirit of the invention, which is only defined by the following claims:

1. A process for preparing milk curd comprises the following steps:
a) Milk skimming;
b) Heating;
c) Temperature drop;
d) Coagulation using ascorbic acid or a salt thereof;
e) Residence; and
f) Separation of the curd.

2. A process according to claim 1, wherein the milk is selected from the group consisting of bovine milk, goat milk, buffalo milk and mixtures thereof.

3. A process according to claim 1, wherein during the skimming the fat is separated until milk reaches a fat content of less than 0.5% p/p.

4. A process according to claim 1, wherein the heating step comprises taking the milk to a temperature between 90.0° C. and 100.0° C.

5. A process according to claim 1, wherein the temperature drop comprises lowering the temperature, wherein the temperature is reduced by 25% with respect to the heating temperature of the milk.

6. A process according to claim 1, wherein ascorbic acid or a salt thereof is used as a coagulating agent.

7. A process according to claim 1, wherein the amount of ascorbic acid added is between 0.5% and 10.0% by weight relative to the total weight of mixture.

8. A process according to claim 1, wherein in the step of residence the mixture is left to stand for a period of time between 1 and 30 minutes.

9. A process according to claim 1, wherein the separation of curd is performed by draining the whey with a sieve which retains the curd.

10. A process for preparing cheese comprising subjecting the curd obtained by the process of claim 1 to one or more further steps selected from the group consisting of salting, molding and pressing.

11. A process according to claim 10, further comprising the step of salting, wherein salt is added to the curd in an amount between 0.01% and 10.0% by weight relative to the total weight of curd.

12. A process according to claim 10, further comprising the step of molding, wherein the salted curd is placed in a mold with a defined geometric shape.

13. A process according to claim 10, further comprising the step of pressing, wherein the pressing is carried out a pneumatic press at a pressure between 130 and 170 KPa for 20 to 60 minutes.

14. Milk curd obtained by the process according to claim 1.

15. Milk curd obtained by the process according to claim 1, characterized by containing between 0.01% and 5.0% residual vitamin C.

16. A cheese obtained by the process according to claim 10.

17. A cheese obtained by the process according to claim 10, characterized by having a lifetime between 60 and 180 days, cooled to 4° C.

18. A cheese obtained by the process according to claim 10, characterized for being a cream cheese, a double cream cheese, fresh cheese, Parmesan cheese, edam cheese or ricotta cheese.

19. A cheese obtained by the process according to claim 10, characterized by containing between 0.01% and 5.0% residual vitamin C.

20. A method for preparing milk curds comprising:
a) heating raw milk to a temperature sufficient to pasteurize the milk;
b) cooling the milk;
c) adding a fruit acid to the milk in an amount sufficient to achieve a pH in the range of 3.5 to 5.5 and
d) incubating the milk and acid mixture;
wherein the acid coagulates the milk to form a composition comprising milk curds.

21. The method of claim 20, comprising heating the raw milk to a temperature of at least 92° C.

22. The method of claim 20, comprising cooling the milk to a temperature between approximately 75° C. and 92° C.

23. The method of claim 20, comprising cooling the milk to a temperature selected from the group consisting of approximately 75° C., 77.5° C., 88° C., and 92° C.

24. The method of claim 20, wherein the fruit acid comprises an acid or a salt thereof selected from the group consisting of ascorbic acid, citric acid, lactic acid, malic acid, steric acid, tartaric acid, and combinations thereof.

25. The method of claim 24, wherein the acid is ascorbic acid or a salt thereof.

26. The method of claim 25, wherein the amount of ascorbic acid added is between 0.5% and 10.0% by weight relative to the total weight of the mixture.

27. The method of claim 20, wherein the amount of acid added is between 0.5% and 10.0% by weight relative to the total weight of the mixture.

28. The method of claim 20, wherein the amount of acid added is between 0.5% and 3.0% by weight relative to the total weight of the mixture.

29. The method of claim 20, wherein the pH of the milk and acid mixture is approximately 5.

30. The method of claim 20, wherein the pH of the milk and acid mixture is selected from the group consisting of 3.7, 3.8, 4.9, 5.1, and 5.25.

31. The method of claim 20, wherein the incubation time is at least 0.5 minute.

32. The method of claim 20, wherein the incubation time is less than 30 minutes.

33. The method of claim 20, wherein the acid coagulates the milk to form a mixture comprising milk curds and whey and the method further comprises separating the curds from the whey.

34. The method of claim 20, further comprising salting the curds.

35. The method of claim 20, further comprising molding the curds.

36. The method of claim 20, further comprising pressing the curds.

37. The method of claim 34, wherein the salt is added to the curds in an amount between 0.01% and 10.0% by weight relative to the total weight of curds.

38. The method of claim 34, wherein the salt is added to the curds in an amount between 1% and 1.5% by weight relative to the total weight of curds.

39. The method of claim 36, comprising pressing the curds at a pressure between 130 and 200 KPa for 20 to 60 minutes.

40. The method of claim 36, comprising pressing the curds at a pressure between 150 and 200 Kpa for 20 to 60 minutes.

41. The method of claim 20, wherein the milk is selected from the group consisting of bovine milk, goat milk, buffalo milk and mixtures thereof.

42. Milk curd obtained by the method according to claim 20.

43. Milk curd obtained by the method according to claim 20, characterized by containing between 0.01% and 5.0% residual vitamin C.

44. Milk curd obtained by the method according to claim 20, characterized by containing between 0.2% and 0.25% residual vitamin C.

45. A cheese obtained by the method according to claim 20.

46. A cheese obtained by the method according to claim 20, characterized by having a lifetime between 60 and 180 days, cooled to 4° C.

47. A cheese obtained by the method according to claim 20 that is selected from the group consisting of cream cheese, a type of mozzarella, fresh white cheese, a type of Parmesan cheese, a type of Edam cheese and ricotta cheese.

48. A cheese obtained by the method according to claim 20, characterized by containing between 0.01% and 5.0% residual vitamin C.

49. A cheese obtained by the method according to claim 20, characterized by containing between 0.2% and 0.25% residual vitamin C.
